(19) United States
(12) Patent Application Publication
(10) Pub. No.: US 2022/0345778 A1
(43) Pub. Date: Oct. 27, 2022

(54) METHOD AND SYSTEM FOR ENHANCING MEDIA CONTENT CONSUMPTION EXPERIENCES

(71) Applicant: AT&T Intellectual Property I, L.P., Atlanta, GA (US)

(72) Inventors: Nigel Bradley, Canton, GA (US); Rashmi Palamadai, Naperville, IL (US); Eric Zavesky, Austin, TX (US); Ari Craine, Marietta, GA (US); Robert Koch, Norcross, GA (US)

(73) Assignee: AT&T Intellectual Property I, L.P., Atlanta, GA (US)

(21) Appl. No.: 17/240,305

(22) Filed: Apr. 26, 2021

(51) Int. Cl. H04N 21/442; H04N 21/84; H04N 21/845; H04N 21/44; H04N 21/422

(52) U.S. Cl. CPC H04N 21/44218; H04N 21/84; H04N 21/8456; H04N 21/44204; H04N 21/44008; H04N 21/42203

(57) ABSTRACT

Aspects of the subject disclosure may include, for example, obtaining metadata associated with media content to be presented, wherein the metadata identifies different portions of the media content demarcated by timestamps, during presenting of a first portion of the media content on a display device, monitoring a consumption of the media content by a user, detecting a command provided by the user, analyzing the command, determining, based on the analyzing and based on the metadata, that the user desires that a second portion of the media content be played back by the display device and, responsive to the determining, causing the display device to switch from presenting the first portion of the media content to presenting the second portion of the media content based on a particular timestamp that corresponds to the second portion of the media content. Other embodiments are disclosed.

### FIELD OF THE DISCLOSURE

The subject disclosure relates to enhancing media content consumption experiences.

### BACKGROUND

Creation and user consumption of digital media content is increasing at a rapid rate as digital technology, such as smartphones, digital televisions, and other entertainment devices, becomes more ubiquitous in society.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIGS. 2B-2J are block diagrams illustrating example, non-limiting embodiments of functions provided by a digital media companion platform of the system of FIG. 2A, in accordance with various aspects described herein.

FIG. 2K depicts an illustrative embodiment of a method in accordance with various aspects described herein.

FIG. 2L depicts an illustrative embodiment of a method in accordance with various aspects described herein.

FIG. 2M depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enhancing media content consumption experiences. Exemplary embodiments described herein provide a digital media companion platform that is capable of providing experiential functions prior to, during, and/or after a user's media content consumption experience. Media content may include video content, audio content, gaming content, Internet-related content (e.g., web browsing-related content), immersive (e.g., extended reality (XR), such as augmented reality (AR), virtual reality (VR), or mixed reality (MR)) content, and/or the like. The digital media companion platform may be capable of monitoring a user during presentation of media content, and controlling the presentation based on the monitoring and based on metadata associated with the media content. In various embodiments, the digital media companion platform may monitor a user for reactions (e.g., utterances or voice-based commands, gesture-based commands, and/or the like) and/or responses (e.g., attentiveness or the like based on biometric or other sensor data) to presentation of media content, and according to metadata associated with relevant portions of the media content, perform action(s), including, for example, replaying of portions of the media content (e.g., that a user may have missed), playing back portions of the media content that have, or are associated with, a particular nature (e.g., emotional scenes, happy scenes, heartwarming scenes, funny scenes, action scenes, etc.), flagging or bookmarking of portions of the media content for future playback, generating data (e.g., social media posts, feedback to media content creators/providers, and/or the like) relating to portions of the media content, and/or the like, as described herein.

One or more aspects of the subject disclosure include a device, comprising a processing system including a processor, and a memory that stores executable instructions that, when executed by the processing system, facilitate performance of operations. The operations can include obtaining metadata associated with media content to be presented, wherein the metadata identifies different portions of the media content demarcated by timestamps. Further, the operations can include, during presenting of a first portion of the media content on a display device, monitoring a consumption of the media content by a user, detecting, from the monitoring, a command provided by the user, analyzing the command responsive to the detecting the command, and determining, based on the analyzing the command and based on the metadata, that the user desires that a second portion of the media content be played back by the display device. Further, the operations can include, responsive to the determining that the user desires that a second portion of the media content be played back by the display device, causing the display device to switch from presenting the first portion of the media content to presenting the second portion of the media content, wherein switching to presenting the second portion of the media content is based on a particular timestamp of the timestamps that corresponds to the second portion of the media content.

One or more aspects of the subject disclosure include a non-transitory machine-readable medium, comprising executable instructions that, when executed by a processing system including a processor, facilitate performance of operations. The operations can include receiving metadata associated with media content, wherein the metadata identifies demarcated portions of the media content. Further, the operations can include, during presenting of the media content on a media display device, monitoring a consumption of the media content by a user, detecting, from the monitoring, that the user has likely become inattentive to the presenting of the media content, and responsive to the detecting that the user has likely become inattentive to the presenting of the media content, identifying, based on the metadata, a portion of the media content that is currently being presented, resulting in an identified portion of the media content. Further, the operations can include identifying that the user is likely no longer inattentive to the presenting of the media content, determining that the identified portion of the media content is to be played back responsive to the identifying that the user is likely no longer inattentive to the presenting of the media content, and based on the determining that the identified portion of the media content is to be played back, causing the media display device to present the identified portion of the media content.

One or more aspects of the subject disclosure include a method. The method can comprise obtaining, by a processing system of a user device including a processor, metadata associated with media content, wherein the metadata identifies different portions of the media content demarcated by timestamps. Further, the method can include, during presenting of the media content on a media display device, monitoring, by the processing system, for reactions of a user to the presenting of the media content, detecting, by the processing system, a particular reaction of the user based on the monitoring, and identifying, by the processing system and based on the detecting the particular reaction and based on the timestamps and a current playback position of the media content, that a first portion of the media content is currently being presented on the media display device. Further, the method can include, responsive to the identifying, deriving, by the processing system, a message that includes information regarding the particular reaction and the first portion of the media content, and responsive to the deriving the message, causing, by the processing system, the message to be transmitted to an external system.

Other embodiments are described in the subject disclosure.

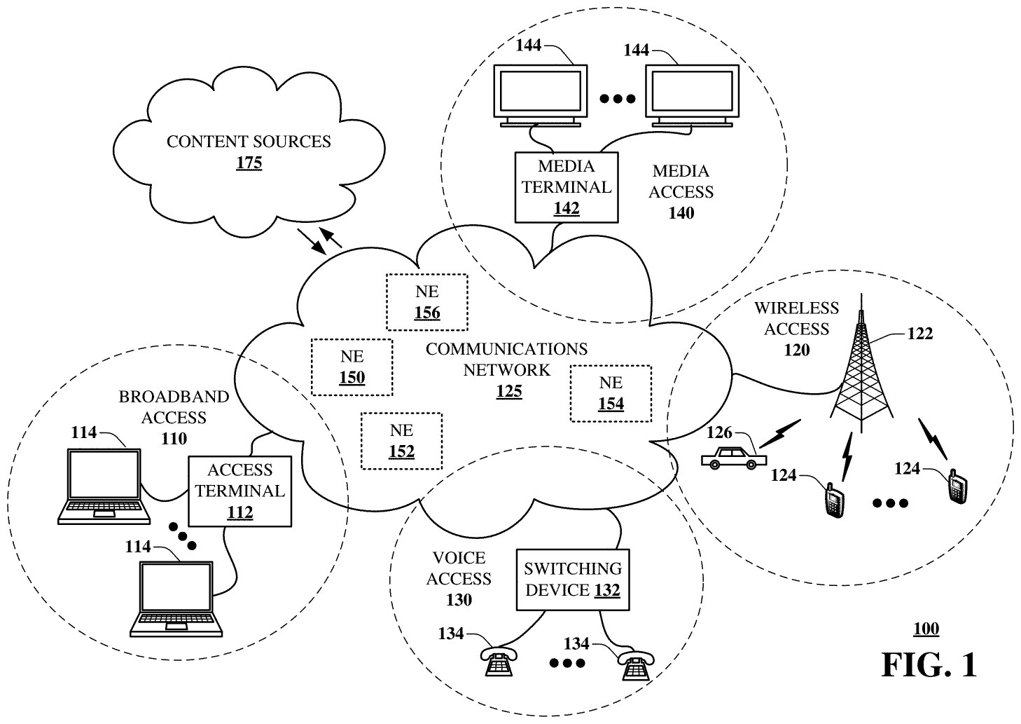

Referring now to FIG. 1, a block diagram is shown illustrating an example, non-limiting embodiment of a system 100 in accordance with various aspects described herein. For example, system 100 can facilitate, in whole or in part, monitoring of a user during presentation of media content, and control of the presentation based on the monitoring and based on metadata associated with the media content. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

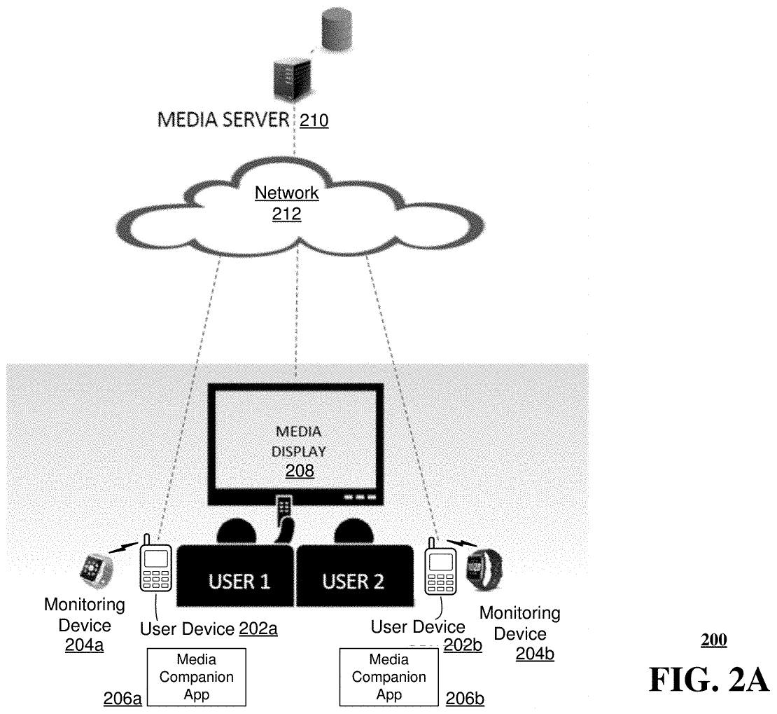

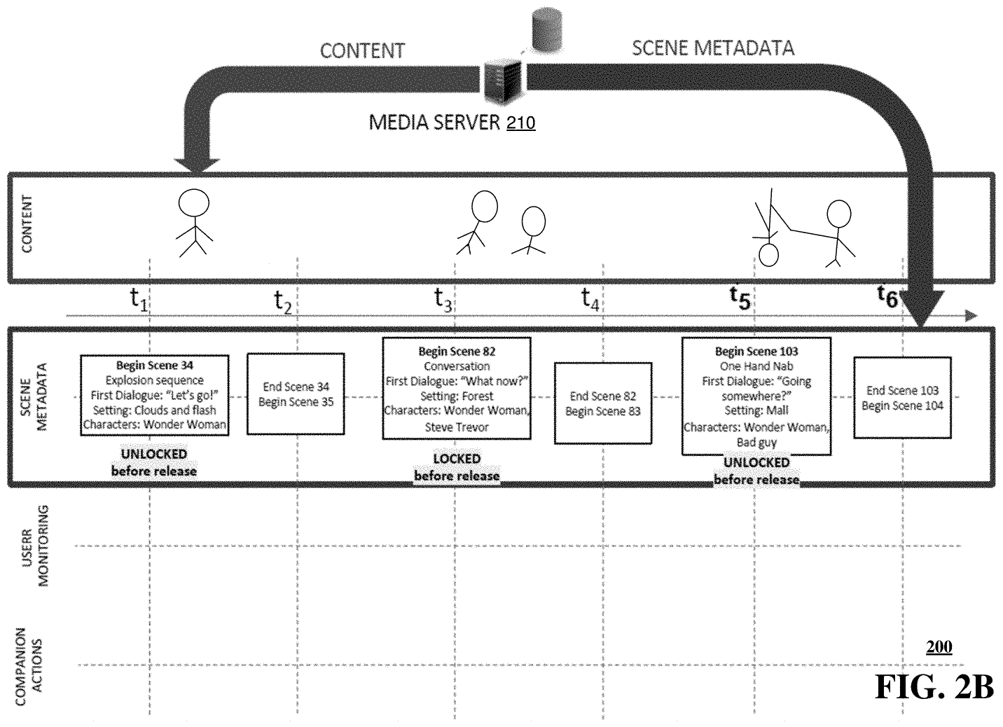

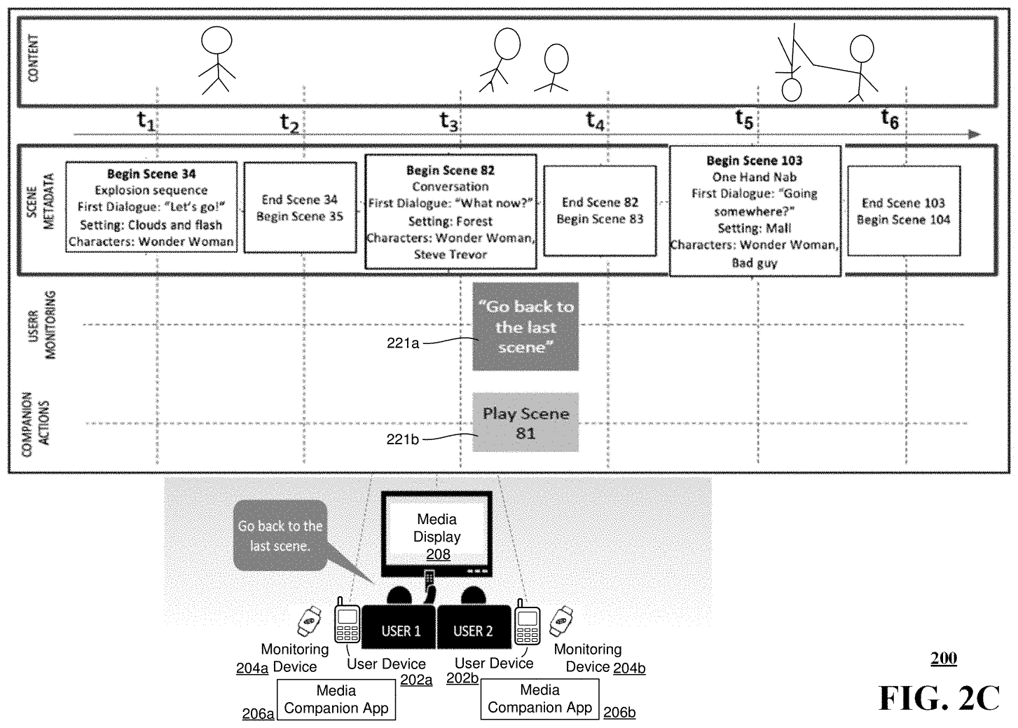

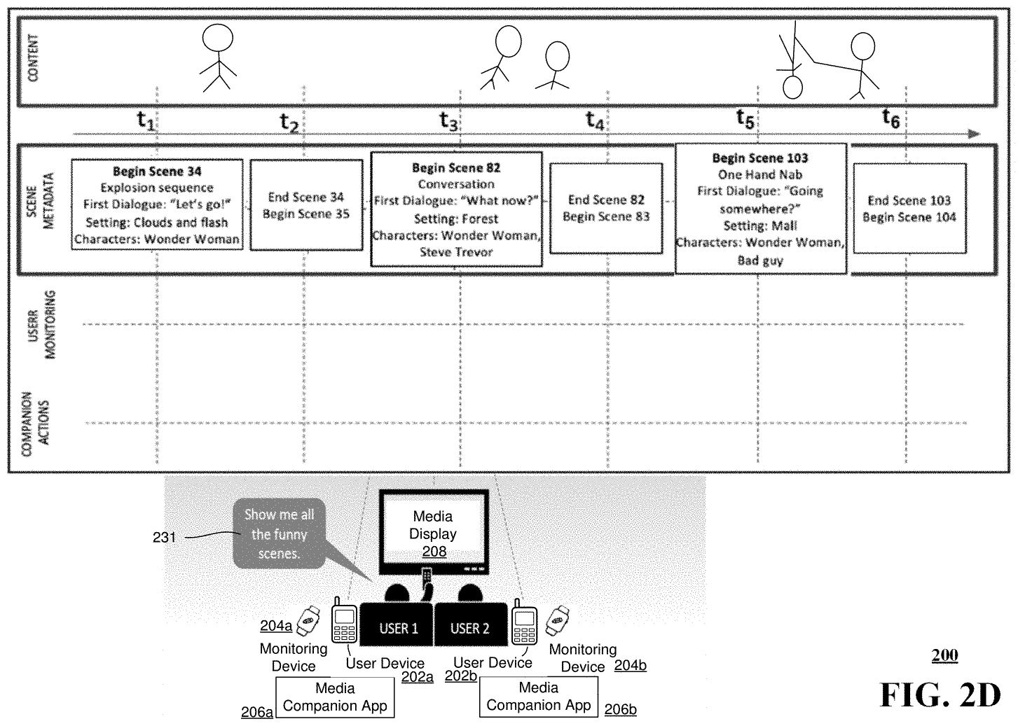

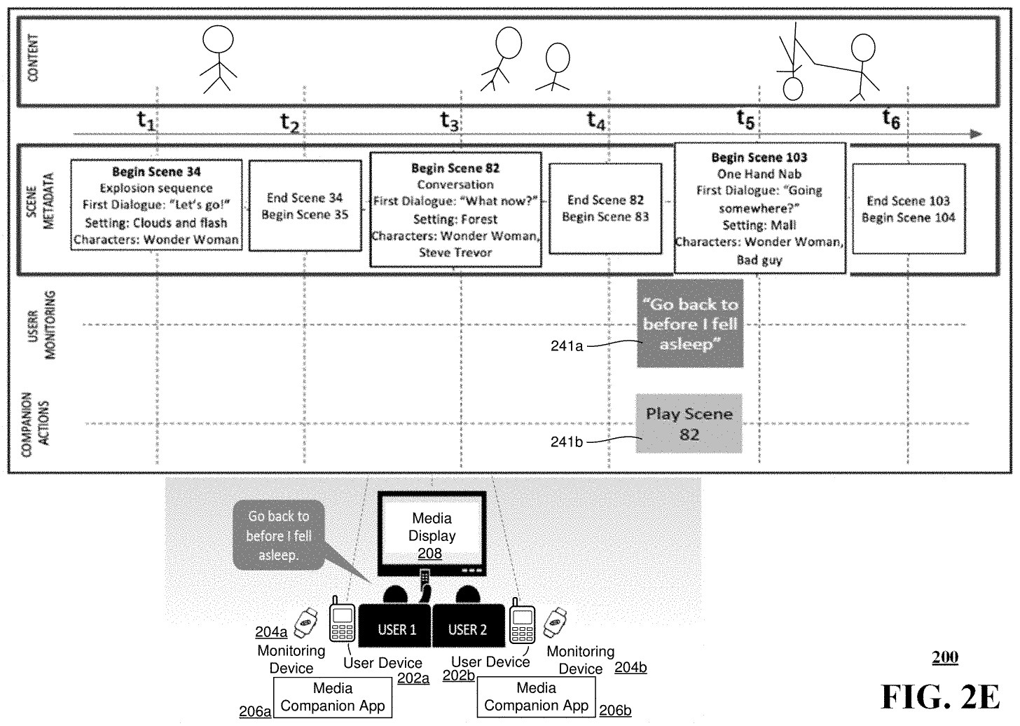

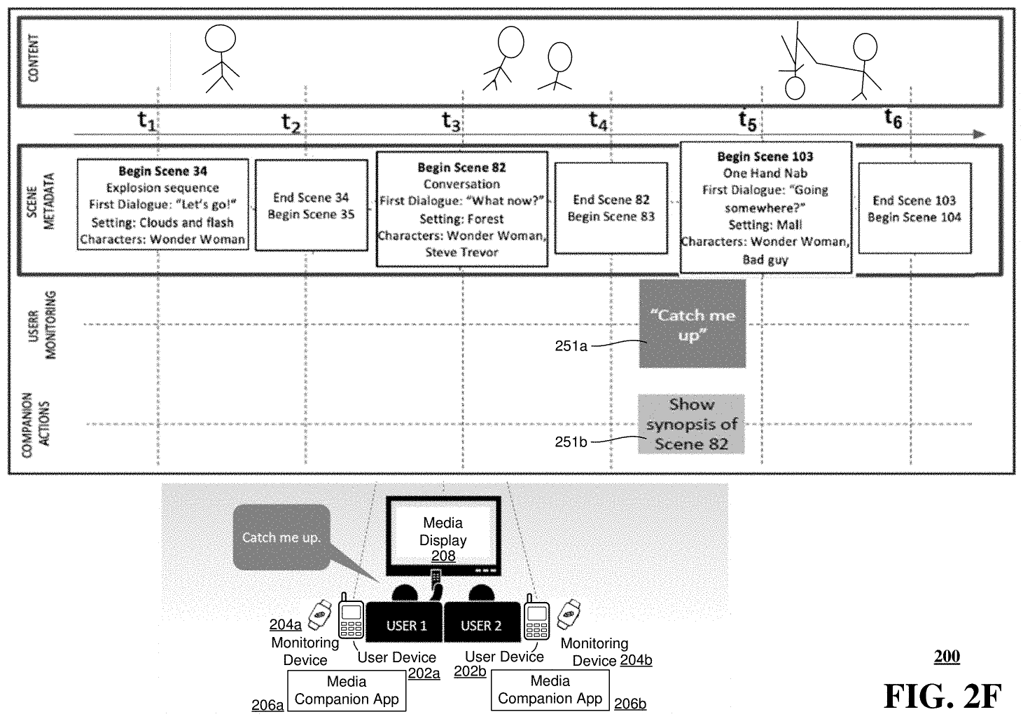

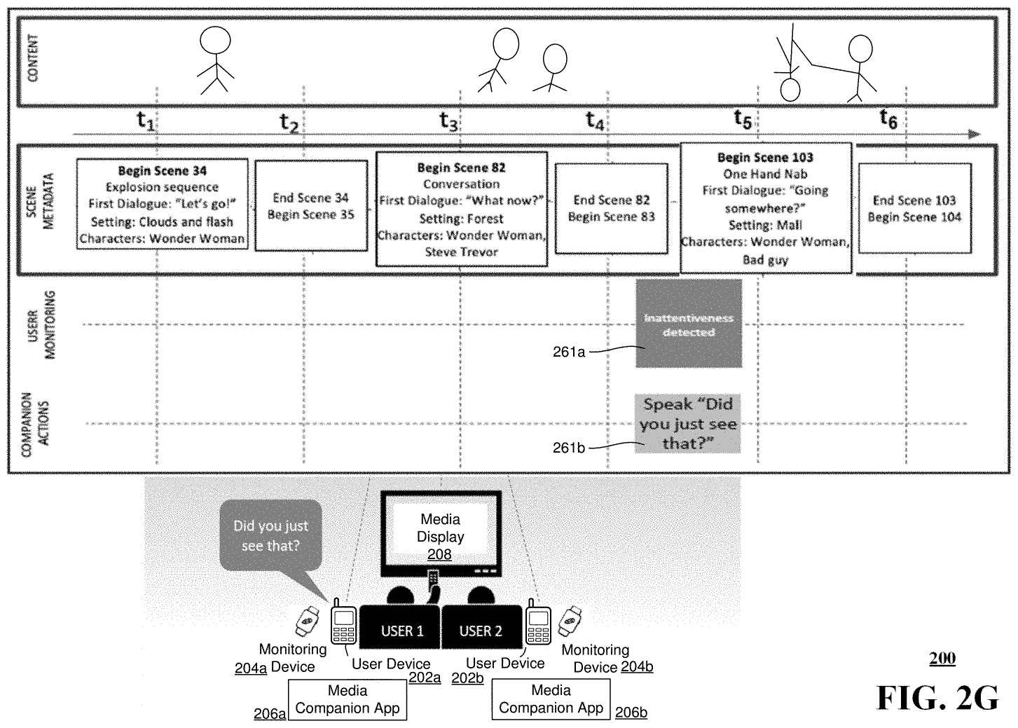

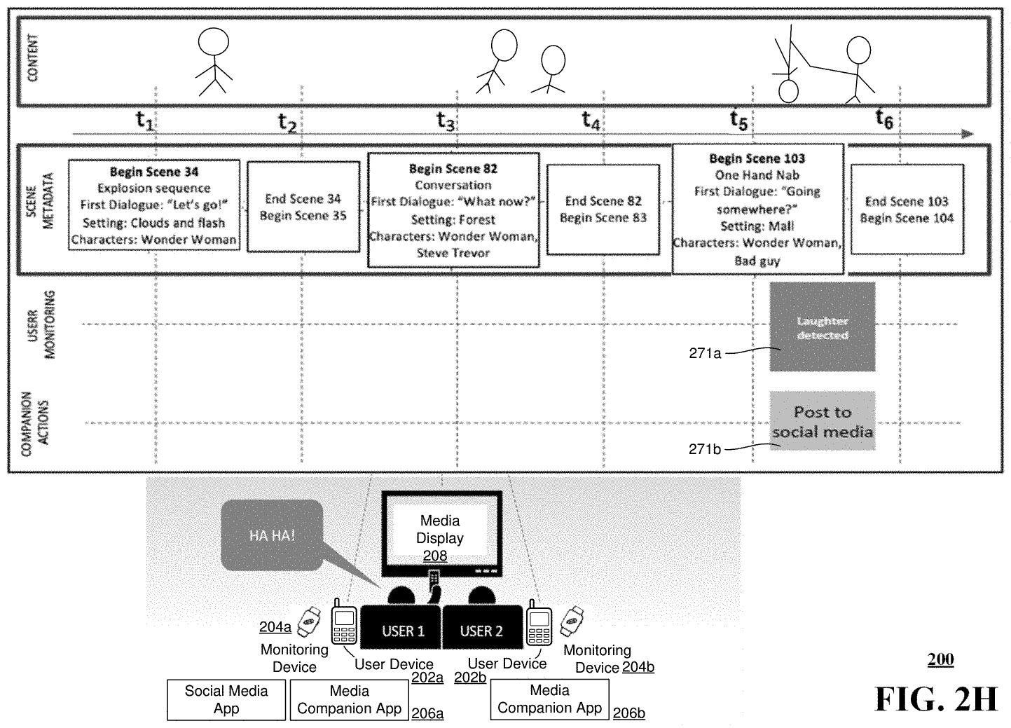

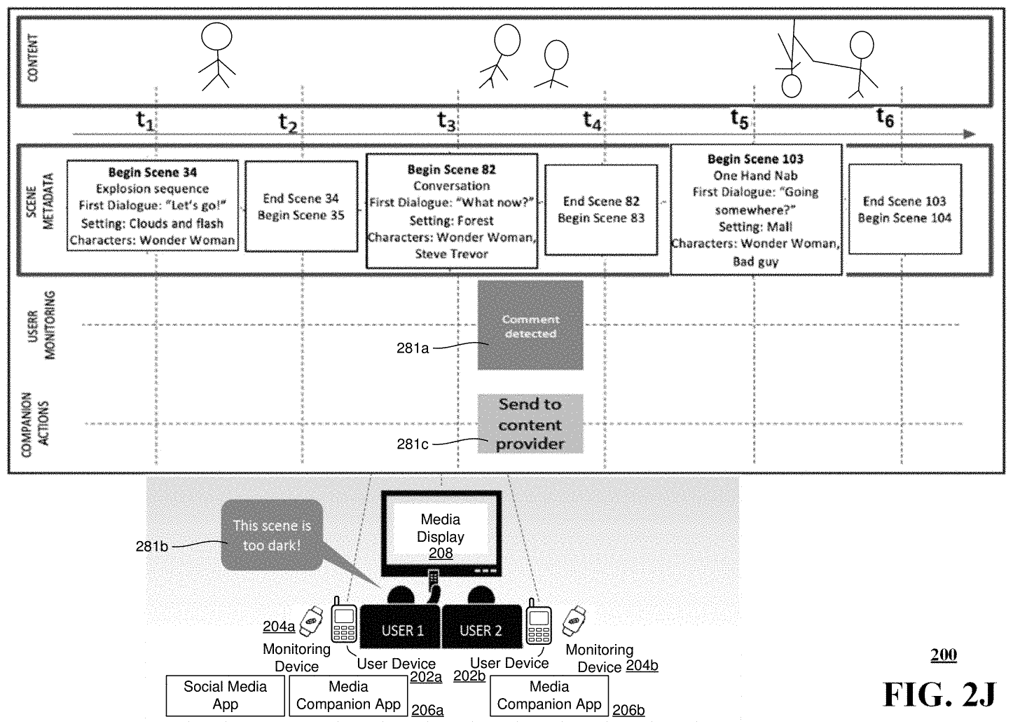

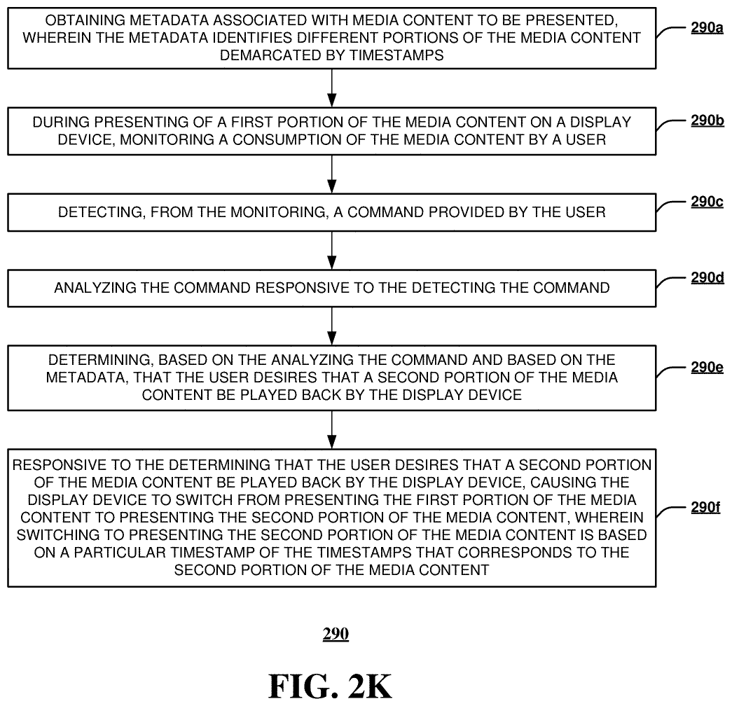

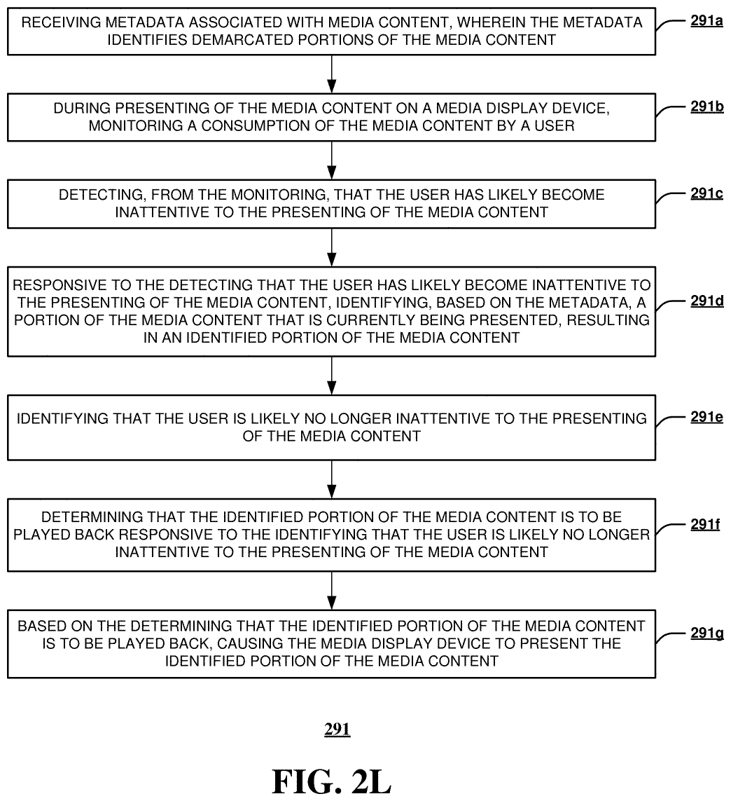

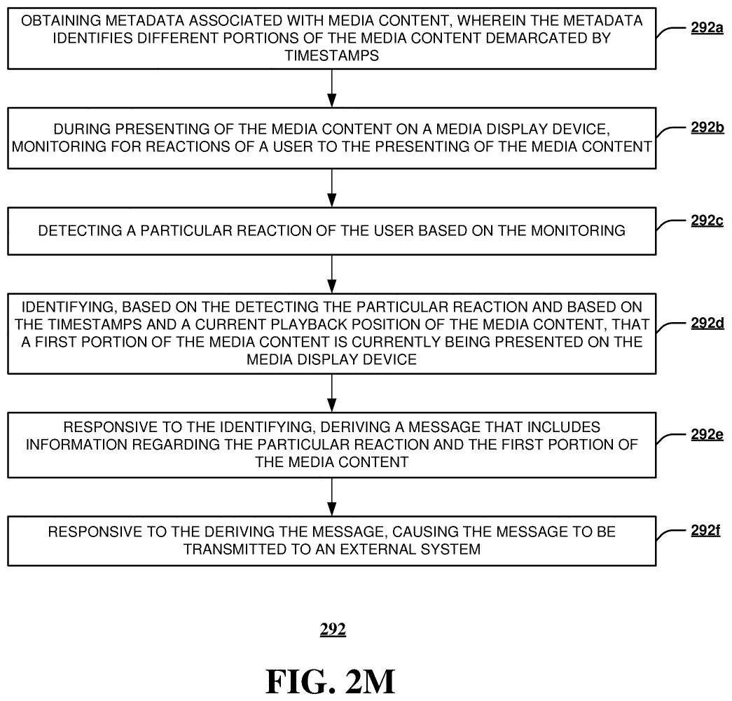

FIG. 2A is a block diagram illustrating an example, non-limiting embodiment of a system 200 functioning within, or overlaid upon, the communications network 100 of FIG. 1 in accordance with various aspects described herein. As shown in FIG. 2A, the system 200 may include a monitoring device 204a and a user device 202a equipped with a digital media companion platform 206a associated with a user 1, and a monitoring device 204b and a user device 202b equipped with a digital media companion platform 206b associated with a user 2. The user device 202a/202b may include one or more devices capable of receiving, generating, storing, processing, and/or providing data (e.g., audio data, video data, gaming data, XR data, text data, control data, etc.) relating to the digital media companion platform 206a/206b. For example, the user device 202a/202b can include a communication and/or computing device, such as a mobile phone (e.g., a smart phone, a radiotelephone, etc.), a desktop computer, a laptop computer, a tablet computer, a handheld computer, a pair of smart eyeglasses, a display device, or a similar type of device.

The monitoring device 204a/204b may include one or more devices equipped with sensors for facilitating biometric monitoring, such as microphone(s) for monitoring a user's breathing, heart rate sensor(s) for monitoring a user's heart rate, and/or the like. For example, the monitoring device 204a/204b may include a wearable communication device (e.g., a smart wristwatch, a fitness tracker, etc.). In some embodiments, a user device (e.g., user device 202a or 202b) may include or function as a monitoring device (e.g., monitoring device 204a or 204b). In such embodiments, the system 200 may not include monitoring device(s) separate from user device(s).

In exemplary embodiments, the digital media companion platform 206a and the digital media companion platform 206b may be distinct instances of an application (or app) that is capable of enhancing a user's media content consumption experiences. In various embodiments, digital media companion platform 206a/206b can include a software package installed, or otherwise operating, on the user device 202a/202b. In some embodiments, the digital media companion platform 206a/206b, when executed by one or more processors of the user device 202a/202b, may cause the one or more processors to present user interface(s) that enable a user to configure the operation of and/or use the digital media companion platform 206a/206b. In certain embodiments, the digital media companion platform 206a/206b may additionally, or alternatively, be implemented in one or more other devices, such as the monitoring device 204a/204b, a media display device, a network, or the like. In some embodiments, the digital media companion platform 206a/206b (e.g., whether implemented as a network-based platform or not) may be executed and synchronized across multiple user devices. In one or more embodiments, the digital media companion platform 206a/206b may be executed on and/or configurable via certain user devices (e.g., one or more parents' user devices or the like), but not other devices (e.g., a child's user device or the like).

As depicted in FIG. 2A, the system 200 may include a media display device 208 and a media server 210. In various embodiments, the media server 210 may be capable of providing media content, such as video/audio content (e.g., Over-The-Top (OTT) media content or the like), gaming content, Internet-related content, immersive (XR) content, and/or the like. In various embodiments, the media server 210 may interact with one or more of the user devices 202a and 202b, the monitoring devices 204a and 204b, and the media display device 208 to facilitate communication and/or delivery of media content. For example, the media server 210 may enable a user (e.g., user 1 and/or user 2) to access the media server 210, and thus media content, via the user device 202a/202b (e.g., via an application, such as a media streaming application, which may include, be associated with, or otherwise be communicatively coupled to, the digital media companion platform 206a/206b).

The media display device 208 may be an end user device, such as a television or a similar display device. In various embodiments, the media display device 208 may include or be communicatively coupled to a media player/controller, such as a set-top box (STB), a video player, an audio player, a gaming device, an immersive content device (e.g., XR gear, such as a pair of AR, VR, MR glasses, a headset, headphones, and/or the like), etc. In exemplary embodiments, the media display device 208 may render and/or present media content, such as streaming media content (e.g., OTT media content, such as video that includes ad pods, long form video, episodes of shows, movies, etc.) and/or the like. In certain embodiments, the media display device 208 may include one or more sensors, such as one or more cameras, microphones, or the like, for monitoring an environment of the media display device 208. In some embodiments, a user device (e.g., user device 202a or 202b) may include or function as a media display device (e.g., media display device 208). In such embodiments, the system 200 may not include a media display device separate from user device(s).

As shown in FIG. 2A, various of the user devices 202a and 202b, the monitoring devices 204a and 204b, the media display device 208, and the media server 210 may be communicatively coupled to one another over a network 212. The network 212 may include one or more wired and/or wireless networks. For example, the network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

It will be appreciated and understood that the system 200 can include any number/types of users, digital media companion platforms, user devices, monitoring devices, media display devices, media servers, and networks, and thus the number/types of users, digital media companion platforms, user devices, monitoring devices, media display devices, media servers, and networks shown in FIG. 2A are for illustrative purposes only.

For simplicity of description, embodiments of the system 200 and/or the digital media companion platform 206a/206b are described herein as relating to video content, such as video streaming. However, it is to be appreciated that various embodiments of the system 200 and/or the digital media companion platform 206a/206b may be capable of enhancing user experiences relating to other types of media content, such as audio content, gaming content, Internet-related content, XR content, etc.

FIGS. 2B-2J are block diagrams illustrating example, non-limiting embodiments of functions provided by the digital media companion platform 206a/206b of the system 200 of FIG. 2A, in accordance with various aspects described herein. In exemplary embodiments, and as shown in FIG. 2B, the media server 210 may be capable of providing metadata associated with media content. In various embodiments, the metadata may be defined, or otherwise provided, by a creator or provider of the media content. The metadata may include tags or the like that provide demarcation information for media content, such as timestamps that correspond to beginnings and ends of different portions (e.g., scenes or the like) of video content (e.g., a movie, a show, etc.). In various embodiments, the metadata, such as scene demarcation information or the like, may be accessible to, and used by, the digital media companion platform 206a/206b, in concert with monitoring of a user (e.g., during presentation of the media content), to facilitate performing of various action(s) relating to the media content for the user, as described in more detail below.

In a case where the media content includes a movie, metadata may—e.g., for each scene of the movie from beginning to end—include tags that identify a description of the scene, a dialogue that takes place in the scene, a setting of the scene, an identification of characters present or involved in the scene, a synopsis of the scene, and/or the like. For example, as shown in FIG. 2B, the metadata may include tags for each scene of a movie (e.g., the film “Wonder Woman”) (although only tags relating to certain scenes of the movie, such as scenes 34, 82, and 103 are shown for illustrative purposes). As depicted in FIG. 2B, the movie may be demarcated into scenes that each begins at a respective time represented by a respective beginning timestamp and ends at another respective time represented by a respective ending timestamp—e.g., scene 34 may begin at a timestamp t₁ and end at a timestamp t₂, scene 82 may begin at a timestamp t₃ and end at a timestamp t₄, and scene 103 may begin at a timestamp t₅ and end at a timestamp t₆.

In some embodiments, certain media content may be made unavailable for user consumption until a certain date or time, such as a release date. In certain embodiments, the media server 210 may provide, or otherwise deliver, media content to users (e.g., user 1 and/or user 2, who may have subscribed to a media content service provided by a provider or operator of the media server 210), such as via the media display device 208, a media player or controller (e.g., an STB or the like associated with the media display device 208), and/or the user devices 202a/202b, but may lock most portions (e.g., most scenes) of the media content until the release date and leave unlocked certain portions (e.g., certain scenes) thereof to allow users to preview the media content. As shown in FIG. 2B, for example, scene 82 of the movie may be locked until the release date, whereas certain other scenes, such as scenes 34 and 103, may be unlocked and available for user preview.

As briefly described above, the digital media companion platform 206a/206b may be configured to monitor a user, during presentation of the media content, to facilitate performing of various action(s) relating to the media content for the user. In various embodiments, the digital media companion platform 206a/206b may be configured to monitor a user's reactions (e.g., utterances or voice-based commands, gestures, or the like), attentiveness of the user, biometric data of the user, and/or the like. In some embodiments, the digital media companion platform 206a/206b may monitor a user based on data or information provided by one or more devices and/or sensors of such device(s). For example, the user device 202a/202b may include one or more location sensors, one or more motion sensors, one or more cameras, one or more input devices (e.g., a touch screen interface, a keyboard, a mouse, etc.), and/or the like, which may generate data or information based on user interaction with the user device 202a/202b that the digital media companion platform 206a/206b may obtain and utilize to monitor a user's reactions and/or attentiveness during presentation of media content. As another example, the monitoring device 204a/204b may include one or more biometric sensors configured to generate biometric data relating to the user, which the digital media companion platform 206a/206b may obtain and utilize for monitoring purposes during presentation of media content.

In various embodiments, the digital media companion platform 206a/206b may control playback, or navigation of presentation, of media content based upon detecting a user's utterances or voice-based commands, gestures, or the like. In some embodiments, the digital media companion platform 206a/206b may obtain data or information regarding the user (e.g., sensor-provided data, as described above), perform various processing of the data or information, such as speech-to-text conversion processing, natural language processing, image-based processing (e.g., facial recognition, gesture recognition, etc.), and/or the like to identify a likely intent or desire of the user, and determine and perform an appropriate action based on the likely intent or desire of the user. For example, as shown by reference number 221a of FIG. 2C, in a case where the user wishes to replay a prior scene of a movie—e.g., by uttering “Go back to the last scene” or the like—the digital media companion platform 206a/206b may, based upon detecting the user's utterance and based upon recognizing (e.g., in accordance with metadata of the movie, such as scene demarcation information or the like) a current playback position or time of the movie, cause the media display device 208 to return to the prior scene. Continuing the example, in a case where the user utters “Go back to the last scene” while scene 82 of the movie is being presented, the digital media companion platform 206a/206b may, based upon detecting the user's utterance and based upon recognizing (e.g., in accordance with scene demarcation information of the movie) that scene 82 is currently being played back and thus scene 81 is the prior scene, cause (221b) the media display device 208 to return to scene 81 (e.g., to return to a playback position corresponding to a beginning of scene 81) so that the user may review scene 81.

As another example, in a case where the user wishes to replay a particular prior scene—e.g., by uttering “Go back to the last scene with Wonder Woman” or the like—the digital media companion platform 206a/206b may, based upon detecting the user's utterance and based upon recognizing, from the metadata, that the most recent prior scene in which the character Wonder Woman appeared is a particular scene, cause the media display device 208 to return to that particular scene (e.g., to return to a playback position corresponding to a beginning of that particular scene, a portion of that particular scene just before Wonder Woman is determined to appear, or the like) so that the user may review that particular scene.

As a further example, in a case where the user wishes to replay a particular prior scene—e.g., by uttering “Go back to the forest scene” or the like—the digital media companion platform 206a/206b may, based upon detecting the user's utterance and based upon recognizing, from the metadata, that the setting of a certain scene, such as scene 82, is in a forest, cause the media display device 208 to return to scene 82 (e.g., to return to a playback position corresponding to the timestamp t₃) so that the user may review scene 82.

In various embodiments, the digital media companion platform 206a/206b may, based upon detecting that replay of a scene is complete, provide the user (e.g., via a visual prompt or audibly) with an option to return to a playback position of the media content just prior to the replay adjustment or to continue viewing the media content (e.g., without any further adjustments). For example, in a case where the user uttered “Go back to the forest scene” or the like while scene 86 of the movie was being presented, and where the digital media companion platform 206a/206b caused the media display device 208 to return to scene 82 responsive to the user's utterance, the digital media companion platform 206a/206b may, based upon detecting that replay of scene 82 is complete, provide the user with an option to return to scene 86 (e.g., where the user left off prior to the replay) or to continue viewing the media content (e.g., from scene 83 on).

In various embodiments, in a case where the digital media companion platform 206a/206b is unable to identify an appropriate playback adjustment—e.g., is unable to determine which prior scene that the user wishes to replay or return to—the digital media companion platform 206a/206b may provide the user (e.g., via a visual prompt or audibly) with information regarding several prior scenes (e.g., descriptions of such scenes as identified in the metadata) and an option to select one of the prior scenes to replay.

In various embodiments, the digital media companion platform 206a/206b may facilitate user searching of (or requests for), and playback of, portions of media content that have or are associated with a particular nature. In some embodiments, metadata of media content may include scene tags that identify a nature of the scene, such as whether the scene is a funny scene, a heartwarming scene, a sad scene, an action scene, a frightening scene, etc., and the digital media companion platform 206a/206b may utilize such scene tags to facilitate user searches/requests. For example, as shown by reference number 231 of FIG. 2D, in a case where the digital media companion platform 206a/206b detects that the user wishes to review some or all of the funny scenes of a movie, the digital media companion platform 206a/206b may identify, based on scene tags of the metadata of the movie, the funny scenes of the movie, and cause the media display device 208 to play back some or all of the identified scenes (e.g., in a random order or sequentially based on a time-based position of the scenes in the media content). In this way, the digital media companion platform 206a/206b may, based upon user request, cause the media display device 208 to play back select scenes in a different order than originally presented when the media content is presented from beginning to end as a whole.

In certain embodiments, the digital media companion platform 206a/206b may identify requested scenes based on a current playback position of media content. For example, in a case where the digital media companion platform 206a/206b detects, while a movie is being played back, that the user wishes to review some or all of the action scenes of a movie, the digital media companion platform 206a/206b may identify, based on scene tags of the metadata of the movie, the action scenes of the movie (e.g., only the action scenes of the movie) that have already been played back during the current presentation of the movie (e.g., so that the user may review such scenes), or alternatively, the action scenes of the movie (e.g., only the action scenes of the movie) that have not yet been played back during the current presentation of the movie (e.g. so that the user may preview what's to come).

In various embodiments, the digital media companion platform 206a/206b may control presentation of media content based on user profile information. User profile information can include data relating to user preferences (e.g., historical explicit preferences, including advertisement placement policy restrictions, opt-in or opt-out preferences, or the like), data relating to user behaviors and/or interests (e.g., historical behaviors, such as Internet browsing activities, content consumption (e.g., videos, games, etc.), purchase histories, and/or the like), demographic data associated with the user (e.g., age of the user, gender of the user, etc.), and/or the like. As an example, in a case where the user is consuming basketball-related media content, and where the digital media companion platform 206a/206b determines, based on the user's profile information that the user likes certain basketball plays or moves, such as slam dunks, the digital media companion platform 206a/206b may, based upon detecting playback of a particular portion of the basketball-related media content that includes a basketball player performing a slam dunk, cause the media display device 208 to automatically replay the particular portion for the user. It is to be appreciated and understood that numerous examples (of media content presentation control based on user profile information) abound. For example, the digital media companion platform 206a/206b may, based on user profile information, flag/bookmark portions of media content, skip over portions of media content, generate clips that include highlights of portions of media content, and so on.

In various embodiments, the digital media companion platform 206a/206b may control playback, or navigation of presentation, of media content based upon detecting likely inattentiveness of a user during presentation of media content. In various embodiments, the digital media companion platform 206a/206b can obtain biometric data or information regarding the user or other information usable to determine user attentiveness or inattentiveness (e.g., camera-provided images of an environment of the user, microphone-provided data, etc.), as described above, and perform various processing of the data or information, such as speech-to-text conversion processing, natural language processing, image-based processing (e.g., facial recognition, gesture recognition, etc.), and/or the like to identify likely user inattentiveness, and determine and perform an appropriate action based on the likely user inattentiveness and metadata associated with the media content. For example, in a case where the digital media companion platform 206a/206b determines (e.g., based on camera images provided by the media display device 208, the user device 202a/202b, or the like, based on biometric data provided by the monitoring device 204a/204b, etc.) that the user is likely dozing off or has likely fallen asleep during presentation of media content, the digital media companion platform 206a/206b may identify (e.g., in accordance with metadata of the movie, such as scene demarcation information or the like) the scene that is currently being presented (e.g., scene 82), and flag or bookmark the scene and/or a current playback position of the media content, to enable the user to later return to the scene or playback position at which the user was determined to have dozed off or fallen asleep. Continuing the example, in a case where the user later awakens and utters “Go back to before I fell asleep” or the like (e.g., as shown by reference number 241a of FIG. 2E), or alternatively, where the digital media companion platform 206a/206b determines (e.g., based on camera images provided by the media display device 208, the user device 202a/202b, or the like, based on biometric data provided by the monitoring device 204a/204b, etc.) that the user has awakened, the digital media companion platform 206a/206b may cause (241b) the media display device 208 to return to the flagged or bookmarked scene (e.g., to return to the beginning of the scene 82 or to the playback position at which the user was determined to have dozed off or fallen asleep) so that the user may continue where the user left off.

As another example, in a case where the digital media companion platform 206a/206b determines (e.g., based on camera images provided by the media display device 208, the user device 202a/202b, or the like, based on biometric data provided by the monitoring device 204a/204b, etc.) that the user is inattentive during presentation of media content (e.g., that the user is using the user device 202a/202b to text, to conduct a phone call, etc.; that the user has moved away (e.g., beyond a threshold distance) from a viewing area of the media display device 208; that the user's eyes are focused in a direction away from the media display device 208; and/or the like), the digital media companion platform 206a/206b may identify (e.g., in accordance with metadata of the movie, such as scene demarcation information or the like) the scene that is currently being presented (e.g., scene 82), and flag or bookmark the scene and/or a current playback position of the media content, to enable the user to later return to the scene or playback position at which the user was determined to have become inattentive. Continuing the example, in a case where the user later resumes attentiveness to the presentation of the media content and utters “Catch me up” or the like (e.g., as shown by reference number 251a of FIG. 2F), or alternatively, where the digital media companion platform 206a/206b determines (e.g., based on camera images provided by the media display device 208, the user device 202a/202b, or the like, based on biometric data provided by the monitoring device 204a/204b, etc.) that the user has resumed attentiveness, the digital media companion platform 206a/206b may cause the media display device 208 to return to the flagged or bookmarked scene (e.g., to return to the beginning of scene 82 or to the playback position at which the user was determined to have dozed off or fallen asleep) so that the user may continue where the user left off. In certain embodiments, the digital media companion platform 206a/206b may additionally, or alternatively, cause information, such as a synopsis or the like (e.g., as shown by reference number 251b in FIG. 2F), regarding the flagged or bookmarked scene (and/or regarding any other subsequent scenes that the user may have missed) to be provided to the user—e.g., via the user device 202a/202b, via the media display device 208, such as in a corner area of a media display screen of the media display device 208, and/or the like.

In various embodiments, in a case where the digital media companion platform 206a/206b determines (e.g., based on camera images provided by the media display device 208, the user device 202a/202b, or the like, based on biometric data provided by the monitoring device 204a/204b, etc.) that the user is inattentive (e.g., reference number 261a of FIG. 2G) during presentation of a scene in which metadata therefor (the scene's tag) identifies has a particular level of significance (e.g., is significant or otherwise important to a storyline of the media content, such as an indication that a certain number of years has passed (e.g., “10 years later”), that a particular character has died, etc.) and thus should not be missed, the digital media companion platform 206a/206b may cause a notification to be presented to the user. For example, as shown by reference number 261b of FIG. 2G, the digital media companion platform 206a/206b may provide a notification (e.g., via a visual prompt or audibly), such as a query “Did you just see that?” or the like, to gain the user's attention. Responsive to detecting the user respond that the user did indeed follow along in the scene (e.g., based on detecting the user uttering “Yes, I did” or the like), the digital media companion platform 206a/206b may maintain presentation of the scene. Conversely, responsive to detecting the user respond that the user actually missed what occurred in the scene (e.g., based on detecting the user uttering “No, I missed that” or the like), the digital media companion platform 206a/206b may cause the media display device 208 to replay the scene (e.g., to return to the beginning of the scene or to the playback position before the user was determined to have become inattentive) so that the user may review the scene.

In exemplary embodiments, the digital media companion platform 206a/206b may, based upon detecting a user's reaction(s) during presentation of media content, facilitate generation of content regarding the user's reaction(s) on one or more of the user's accounts, such as a social media account, a blog, or the like. The digital media companion platform 206a/206b may facilitate the generation of content in accordance with the user's permission, granted credentials, and/or the like. For example, the digital media companion platform 206a/206b may leverage a social media app or the like installed on the user device 202a/202b to facilitate the generation of a post (e.g., reference number 271b of FIG. 2H) based on the user's reaction(s) detected (271a) during presentation of a particular scene of a movie. In various embodiments, the digital media companion platform 206a/206b may enable a user to configure settings for the generation of content, such as to generate a post (271b) whenever the user laughs (271a) at a scene, to generate a post whenever the user utters a certain word or phrase (e.g., “Post that,” “Wow,” etc.), to generate a post whenever the user makes a certain expression (e.g., smiles, sheds tears, and so on), to include a captured image or video clip of the user's reaction in the post, to generate no more than a threshold number of posts (e.g., three posts, five posts, and/or the like) for each scene or for each media content, to include a post source (e.g., “Posted generated by User l's digital media companion app” or the like, which can alert a reader or social acquaintance that the post was made on the user's behalf), to not include such post source information, to include a spoiler alert in the post; to request for the user's final approval prior to submitting a post; and/or the like. In certain embodiments, the digital media companion platform 206a/206b may (e.g., based on the user's permission, granted credentials, and/or the like) facilitate generation of content for other types of user accounts, such as an e-mail account, a text message account, etc.—e.g., where the digital media companion platform 206a/206b may automatically send a text or an e-mail to a designated friend or family member regarding the user's reaction(s) or media consumption experience.

In various embodiments, the digital media companion platform 206a/206b may aggregate (e.g., over time), in a collection or highlight reel, portions of one or more media content items (e.g., scenes of one or more movies or the like) that the user was determined to have reacted to (e.g., that the user was determined to have laughed during, cried during, screamed during, or exhibited some other emotional expression during) and/or that the user requested the digital media companion platform 206a/206b (e.g., via voice-based command or the like) to tag or bookmark as a favorite. The digital media companion platform 206a/206b may store the collection or highlight reel in the user device 202a/202b, the media display device 208, the media server 210, the network 212, and/or the like, and may present the collection or highlight reel to the user upon request, or alternatively, when the digital media companion platform 206a/206b determines that the user is browsing for media content to consume and that presenting the collection or highlight reel to the user may aid the user in identifying a suitable media content to consume.

In various embodiments, the digital media companion platform 206a/206b may (e.g., based on user permissions, such as opt-in permissions or the like) provide information regarding user reactions, attentiveness or inattentiveness, or the like, during presentation of media content, as feedback to content creator(s) or content provider(s), which can enable content creator(s) or content provider(s) to gauge user reception of the media content and/or to improve future media content offerings. For example, the digital media companion platform 206a/206b may (e.g., based on camera images provided by the media display device 208, the user device 202a/202b, or the like, based on biometric data provided by the monitoring device 204a/204b, etc., as described above) detect a user's reaction (e.g., a user utterance of “This scene is too dark” or the like, as shown by reference numbers 281a and 281b of FIG. 2H) and/or inattentiveness (e.g., the user falling asleep or the like), associate the detection with a scene of the media content that is currently being presented, and provide (281c) (e.g., in real-time or near real-time), to content creator(s)/provider(s) (or media content review databases or the like), information regarding the detection and the corresponding scene as commentary, or proxy commentary, on a quality of the media content or as an indication of a level of viewer engagement during presentation of the media content.

Although FIGS. 2A-2J are described above as involving a digital media companion platform that provides media consumption-related experiential functions for a user (e.g., a user 1, a user 2, etc.), embodiments of the digital media companion platform may enable interaction between multiple digital media companion platforms of multiple users (e.g., digital media companion platform 206a associated with user 1, digital media companion platform 206b associated with user 2, etc.), and facilitate control of presentation of media content and/or perform action(s) relating to the media content, in a multi-user setting.

In various embodiments, each of multiple digital media companion platforms (e.g., digital media companion platform 206a associated with user 1, digital media companion platform 206b associated with user 2, etc.) may be communicatively coupled with a media display device (e.g., the media display device 208) and/or a media player/controller associated with the media display device, and may be configured to independently facilitate control of presentation of media content on the media display device and/or perform action(s) relating to the media content. For example, the digital media companion platform 206a may independently monitor the user 1 (e.g., for user 1's reactions, commands, attentiveness, etc., as described above) and/or perform action(s) relating to presentation of media content (e.g., replaying certain portions of the media content, generating/providing social media content and/or feedback, etc., as described above), and the digital media companion platform 206b may similarly independently monitor the user 2 and/or perform action(s) relating to presentation of the media content.

In some cases, permitting multiple digital media companion platforms (e.g., the digital media companion platform 206a, the digital media companion platform 206b, etc.) to have full, independent control of a media display device (e.g., the media display device 208) in a multi-user setting may result in interference or conflicts, such as in a case where a first user (e.g., user 1) commands a corresponding digital media companion platform (e.g., digital media companion platform 206a) to replay a prior scene of a movie, but a second user (e.g., user 2) prefers to continue watching the movie. Therefore, in various embodiments, a digital media companion platform (e.g., each digital media companion platform) may be assigned a priority by the media display device and/or a media player/controller associated with the media display device, where primary control of the media display device and/or the media player/controller may be provided based on the assigned priority. In some embodiments, assignments of priorities to digital media companion platforms may be made (e.g., user defined) in configuration settings of the media display device and/or the media player/controller. In a case where the digital media companion platform 206a, for example, is assigned a first priority that is higher than a second priority assigned to the digital media companion platform 206b, the digital media companion platform 206a may have primary control of presentation of media content on the media display device 208. In certain embodiments, a second digital media companion platform that is assigned a lower priority (e.g., the digital media companion platform 206b) may (e.g., based on a command provided by a user associated with that digital media companion platform, such as user 2) request a first digital media companion platform that is assigned a higher priority (e.g., the digital media companion platform 206a) for permission to control presentation of media content. For instance, in a case where the digital media companion platform 206b detects a request from user 2 to replay a prior scene during presentation of media content, and where the digital media companion platform 206b, the digital media companion platform 206a, the media display device 208, and/or a media player/controller associated with the media display device 208 determines that the digital media companion platform 206a has primary control of presentation of media content, the digital media companion platform 206b (and/or the media display device 208 or media player/controller) may transmit a request to the digital media companion platform 206a for user 1's permission to replay the prior scene.

In some cases, in a multi-user setting, a user (e.g., user 2) may become inattentive, or may leave a viewing area, during presentation of media content. In such cases, the digital media companion platform 206b may (e.g., similar to that described above with respect to FIGS. 2E and/or 2F) flag or bookmark the portion of the media content being presented when the digital media companion platform 206b determined that the user 2 became inattentive or left the viewing area, which may permit user 2 to later resume consumption of the media content where the user 2 left off—e.g., without interrupting or impacting user 1's present consumption of the media content.

In various embodiments, a first digital media companion platform may notify other digital media companion platform(s) when the first digital media companion platform detects or determines that a corresponding user has fallen asleep, has become inattentive, has awakened, has resumed attentiveness, and/or the like. This may enable user(s) of the other digital media companion platform(s) to determine appropriate actions to take, such as stopping presentation of the media content, replaying a prior scene (e.g., based upon which portion or scene of the media content that the first digital media companion platform determined was being presented when the user was determined to be inattentive), etc. For example, in a case where the digital media companion platform 206b determines that user 2 fell asleep, became inattentive, or the like during presentation of media content, the digital media companion platform 206b may submit a request to the digital media companion platform 206a to provide a notification to user 1 regarding such a determination, which may enable user 1 to halt or pause a presentation of the media content or to engage user 2 (e.g., to wake up user 2 or the like). In various embodiments, the digital media companion platform 206b may submit a request to the digital media companion platform 206a to provide an option to user 1 to return to a portion of the media content that the digital media companion platform 206b determined was being presented when the digital media companion platform 206b detected user 2's inattentiveness. In some embodiments, such as in a case where user 1 in the foregoing example chooses not to halt or pause the presentation of the media content or not to return to a prior scene where user 2 was determined to have fallen asleep or become inattentive, the digital media companion platform 206b may cause information regarding the missed content, such as a synopsis of one or more missed scenes to be provided to user 2 (e.g., similar to that described above with respect to FIG. 2F).

Various embodiments of the system 200 may enable users at different locations to jointly, or concurrently, consume media content at their respective locations. For example, in some cases, users may not be physically located in a same viewing area during presentation of media content, but may wish to remotely participate in a joint media content consumption session, such as a viewing party or the like. In such cases, embodiments of the system 200 may permit synchronized presentation of media content, at respective media display devices and/or associated media players/controllers of the users, to simulate, or provide, a multi-user media content consumption session or experience.

In various embodiments, digital media companion platforms may interact with one another to confirm, and/or determine patterns associated with, respective monitored user reactions, biometric data, or the like. For example, in a multi-user setting, in a case where the digital media companion platform 206b determines, based on data or information provided by the monitoring device 204b, that user 2 has an elevated or lowered heart rate, the digital media companion platform 206b may communicate with the digital media companion platform 206a to determine whether the digital media companion platform 206a has also similarly detected an elevated or lower heart rate of user 1. Comparing such information may enable a digital media companion platform to assess measurement or detection accuracy and judge whether user reactions/responses (e.g., elevated or lowered heart rates) may be influenced by what is being presented in media content (e.g., an action scene, a frightening scene, etc.). In some embodiments, a digital media companion platform may learn (e.g., via one or more machine learning algorithm(s)) over time that a user may prefer or be fond certain types of media content, such as certain types of scenes (e.g., action scenes, etc.) based on the user's reactions/responses (e.g., utterances, elevated or lowered heart rates, etc.), which the digital media companion platform may leverage to recommend media content to the user, to facilitate social interaction between the user and other users (e.g., by sharing data/information regarding the user with respect to certain scenes in media content), and/or the like.

In certain embodiments, digital media companion platforms may identify potential common interests of users, which may also spur social engagement. For example, digital media companion platforms of different users may (e.g., whether the users are consuming media content in a multi-user setting, in a remote joint session, or even at different times) respectively monitor user reactions/responses relative to portions (e.g., scenes) of the media content, store monitored data, and/or share the monitored data with one another. This may promote social interaction, and enable the digital media companion platforms, a media server (e.g., the media server 210), and/or the like to provide recommendations to users regarding available media content that others with similar interests or preferences have consumed; to notify users that others have reacted similarly to certain scenes of media content; and/or the like. For instance, in a case where user 1 and a user 3 are determined to be associated with one another (e.g., are friends on social media, etc.), and where the digital media companion platform 206a determines that user 1 is reacting/responding in a certain way to media content (e.g., is laughing at a scene of a movie or the like), the digital media companion platform 206a may notify a digital media companion platform corresponding to the user 3 regarding user 1's reaction to the media content, which may promote social engagement/interaction between user 1 and user 3. In various embodiments, and depending on user 1's opt-in permissions or the like, the digital media companion platform 206a may either identify user 1 in the notification or otherwise indicate (e.g., only indicate) that a user associated with user 3 has reacted/responded to the media content.

Although the description of various embodiments of the system 200 and/or the digital media companion platform 206a/206b herein focuses on video content consumption (e.g., streaming videos or the like), the embodiments can also be applied to other types of media content, such as audio content, gaming content, Internet-related content, XR content, and/or the like. As one example, in a case where a user is consuming content on the Internet, such as browsing through a microblogging site (e.g., Twitter or the like), the digital media companion platform may be configured to monitor the user's reactions during the browsing and perform action(s) accordingly (e.g., automatically retweeting or bookmarking a tweet based upon detecting the user laugh at another user's tweet, and/or the like). As another example, in a case where a user is engaged in a gaming session (e.g., a first person shooter game), the digital media companion platform may be configured to monitor the user's reactions or biological responses (e.g., heart rate, breathing, etc.) during the gaming and perform action(s) accordingly (e.g., automatically generating one or more video clips of the user's in-game character making kills in the first person shooter game, automatically generating one or more video clips of the user's game play during periods where the user's heart rate or breathing rate satisfied a threshold, and/or the like).

It is also to be understood and appreciated that the quantity and arrangement of digital media companion platforms, apps, user devices, monitoring devices, media display devices, media servers, and networks shown in or described with respect to FIGS. 2A-2J are provided as examples. In practice, there may be additional digital media companion platforms, apps, user devices, monitoring devices, media display devices, media servers, and networks, or differently arranged digital media companion platforms, apps, user devices, monitoring devices, media display devices, media servers, and networks than those shown in or described with respect to FIGS. 2A-2J. For example, the system 200 can include more or fewer digital media companion platforms, apps, user devices, monitoring devices, media display devices, media servers, and networks, etc. Furthermore, two or more digital media companion platforms, apps, user devices, monitoring devices, media display devices, media servers, and networks shown in or described with respect to one or more of FIGS. 2A-2J may be implemented within a single digital media companion platform, app, user device, monitoring device, media display device, media server, and network, or a single digital media companion platform, app, user device, monitoring device, media display device, media server, and network shown in or described with respect to one or more of FIGS. 2A-2J may be implemented as multiple, distributed digital media companion platforms, apps, user devices, monitoring devices, media display devices, media servers, and networks. Additionally, or alternatively, a set of digital media companion platforms, apps, user devices, monitoring devices, media display devices, media servers, and networks (e.g., one or more digital media companion platforms, apps, user devices, monitoring devices, media display devices, media servers, and networks) of the system 200 may perform one or more functions described as being performed by another set of digital media companion platforms, apps, user devices, monitoring devices, media display devices, media servers, and networks of the system 200.

FIG. 2K depicts an illustrative embodiment of a method 290 in accordance with various aspects described herein. In some embodiments, one or more process blocks of FIG. 2K can be performed by a digital media companion platform, such as the digital media companion platform 206a/206b of the user device 202a/202b. In some embodiments, one or more process blocks of FIG. 2K may be performed by another device or a group of devices separate from or including the digital media companion platform 206a/206b of the user device 202a/202b, such as the monitoring device 204a/204b, the media display device 208, the media server 210, or the network 212.

At 290a, the method can include obtaining metadata associated with media content to be presented, wherein the metadata identifies different portions of the media content demarcated by timestamps. For example, the digital media companion platform 206a/206b of the user device 202a/202b can obtain metadata associated with media content to be presented in a manner similar to that described above with respect to the system 200 of FIG. 2A, where the metadata identifies different portions of the media content demarcated by timestamps.

At 290b, the method can include, during presenting of a first portion of the media content on a display device, monitoring a consumption of the media content by a user. For example, the digital media companion platform 206a/206b of the user device 202a/202b can, during presenting of a first portion of the media content on a display device, monitor a consumption of the media content by a user in a manner similar to that described above with respect to the system 200 of FIG. 2A.

At 290c, the method can include detecting, from the monitoring, a command provided by the user. For example, the digital media companion platform 206a/206b of the user device 202a/202b can detect, from the monitoring, a command provided by the user in a manner similar to that described above with respect to the system 200 of FIG. 2A.

At 290d, the method can include analyzing the command responsive to the detecting the command. For example, the digital media companion platform 206a/206b of the user device 202a/202b can analyze the command responsive to the detecting the command in a manner similar to that described above with respect to the system 200 of FIG. 2A.

At 290e, the method can include determining, based on the analyzing the command and based on the metadata, that the user desires that a second portion of the media content be played back by the display device. For example, the digital media companion platform 206a/206b of the user device 202a/202b can determine, based on the analyzing the command and based on the metadata, that the user desires that a second portion of the media content be played back by the display device in a manner similar to that described above with respect to the system 200 of FIG. 2A.

At 290f, the method can include, responsive to the determining that the user desires that a second portion of the media content be played back by the display device, causing the display device to switch from presenting the first portion of the media content to presenting the second portion of the media content, wherein switching to presenting the second portion of the media content is based on a particular timestamp of the timestamps that corresponds to the second portion of the media content. For example, the digital media companion platform 206a/206b of the user device 202a/202b can, responsive to the determining that the user desires that a second portion of the media content be played back by the display device, cause the display device to switch from presenting the first portion of the media content to presenting the second portion of the media content, in a manner similar to that described above with respect to the system 200 of FIG. 2A, where switching to presenting the second portion of the media content is based on a particular timestamp of the timestamps that corresponds to the second portion of the media content.

FIG. 2L depicts an illustrative embodiment of a method 291 in accordance with various aspects described herein. In some embodiments, one or more process blocks of FIG. 2L can be performed by a digital media companion platform, such as the digital media companion platform 206a/206b of the user device 202a/202b. In some embodiments, one or more process blocks of FIG. 2L may be performed by another device or a group of devices separate from or including the digital media companion platform 206a/206b of the user device 202a/202b, such as the monitoring device 204a/204b, the media display device 208, the media server 210, or the network 212.

At 291a, the method can include receiving metadata associated with media content, wherein the metadata identifies demarcated portions of the media content. For example, the digital media companion platform 206a/206b of the user device 202a/202b can receive metadata associated with media content in a manner similar to that described above with respect to the system 200 of FIG. 2A, where the metadata identifies demarcated portions of the media content.

At 291b, the method can include, during presenting of the media content on a media display device, monitoring a consumption of the media content by a user. For example, the digital media companion platform 206a/206b of the user device 202a/202b can, during presenting of the media content on a media display device, monitor a consumption of the media content by a user in a manner similar to that described above with respect to the system 200 of FIG. 2A.

At 291c, the method can include detecting, from the monitoring, that the user has likely become inattentive to the presenting of the media content. For example, the digital media companion platform 206a/206b of the user device 202a/202b can detect, from the monitoring, that the user has likely become inattentive to the presenting of the media content in a manner similar to that described above with respect to the system 200 of FIG. 2A.

At 291d, the method can include, responsive to the detecting that the user has likely become inattentive to the presenting of the media content, identifying, based on the metadata, a portion of the media content that is currently being presented, resulting in an identified portion of the media content. For example, the digital media companion platform 206a/206b of the user device 202a/202b can, responsive to the detecting that the user has likely become inattentive to the presenting of the media content, identify, based on the metadata, a portion of the media content that is currently being presented, resulting in an identified portion of the media content in a manner similar to that described above with respect to the system 200 of FIG. 2A.

At 291e, the method can include identifying that the user is likely no longer inattentive to the presenting of the media content. For example, the digital media companion platform 206a/206b of the user device 202a/202b can identify that the user is likely no longer inattentive to the presenting of the media content in a manner similar to that described above with respect to the system 200 of FIG. 2A.

At 291f, the method can include determining that the identified portion of the media content is to be played back responsive to the identifying that the user is likely no longer inattentive to the presenting of the media content. For example, the digital media companion platform 206a/206b of the user device 202a/202b can determine that the identified portion of the media content is to be played back responsive to the identifying that the user is likely no longer inattentive to the presenting of the media content in a manner similar to that described above with respect to the system 200 of FIG. 2A.

At 291g, the method can include, based on the determining that the identified portion of the media content is to be played back, causing the media display device to present the identified portion of the media content. For example, the digital media companion platform 206a/206b of the user device 202a/202b can, based on the determining that the identified portion of the media content is to be played back, cause the media display device to present the identified portion of the media content in a manner similar to that described above with respect to the system 200 of FIG. 2A.

FIG. 2M depicts an illustrative embodiment of a method 292 in accordance with various aspects described herein. In some embodiments, one or more process blocks of FIG. 2M can be performed by a digital media companion platform, such as the digital media companion platform 206a/206b of the user device 202a/202b. In some embodiments, one or more process blocks of FIG. 2M may be performed by another device or a group of devices separate from or including the digital media companion platform 206a/206b of the user device 202a/202b, such as the monitoring device 204a/204b, the media display device 208, the media server 210, or the network 212.

At 292a, the method can include obtaining metadata associated with media content, wherein the metadata identifies different portions of the media content demarcated by timestamps. For example, the digital media companion platform 206a/206b of the user device 202a/202b can obtain metadata associated with media content in a manner similar to that described above with respect to the system 200 of FIG. 2A, where the metadata identifies different portions of the media content demarcated by timestamps.

At 292b, the method can include, during presenting of the media content on a media display device, monitoring for reactions of a user to the presenting of the media content. For example, the digital media companion platform 206a/206b of the user device 202a/202b can, during presenting of the media content on a media display device, monitor for reactions of a user to the presenting of the media content in a manner similar to that described above with respect to the system 200 of FIG. 2A.

At 292c, the method can include detecting a particular reaction of the user based on the monitoring. For example, the digital media companion platform 206a/206b of the user device 202a/202b can detect a particular reaction of the user based on the monitoring in a manner similar to that described above with respect to the system 200 of FIG. 2A.

At 292d, the method can include identifying, based on the detecting the particular reaction and based on the timestamps and a current playback position of the media content, that a first portion of the media content is currently being presented on the media display device. For example, the digital media companion platform 206a/206b of the user device 202a/202b can identify, based on the detecting the particular reaction and based on the timestamps and a current playback position of the media content, that a first portion of the media content is currently being presented on the media display device in a manner similar to that described above with respect to the system 200 of FIG. 2A.

At 292e, the method can include, responsive to the identifying, deriving a message that includes information regarding the particular reaction and the first portion of the media content. For example, the digital media companion platform 206a/206b of the user device 202a/202b can, responsive to the identifying, derive a message that includes information regarding the particular reaction and the first portion of the media content in a manner similar to that described above with respect to the system 200 of FIG. 2A.

At 292f, the method can include, responsive to the deriving the message, causing the message to be transmitted to an external system. For example, the digital media companion platform 206a/206b of the user device 202a/202b can, responsive to the derive the message, causing the message to be transmitted to an external system in a manner similar to that described above with respect to the system 200 of FIG. 2A.

While for purposes of simplicity of explanation, the respective processes are shown and described as a series of blocks in each of FIGS. 2K-2M, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

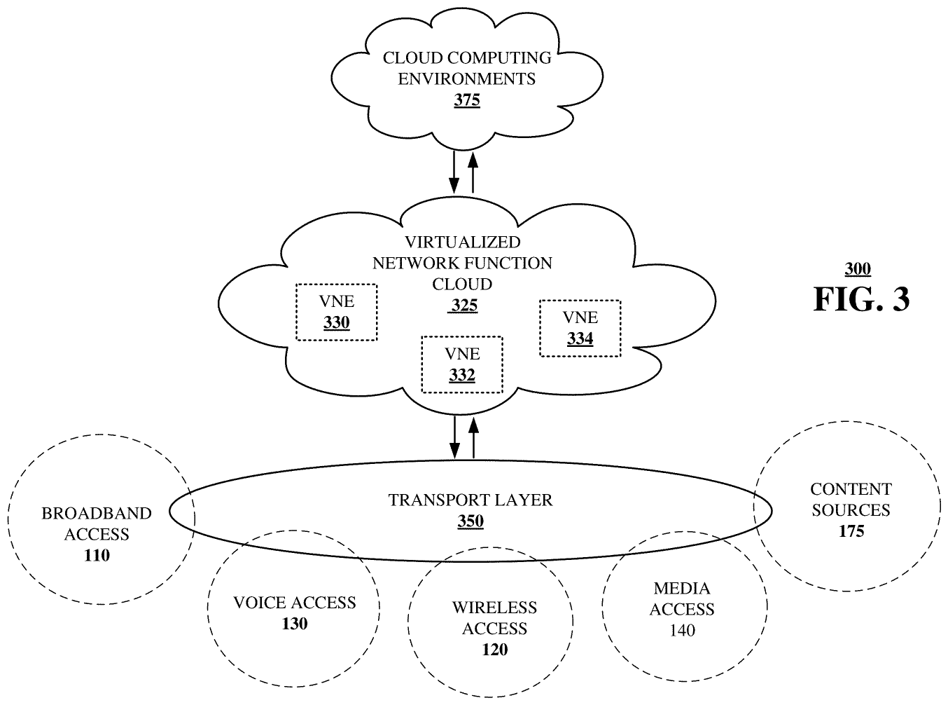

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and methods 290-292 presented in FIGS. 1 and 2A-2M. For example, virtualized communications network 300 can facilitate, in whole or in part, monitoring of a user during presentation of media content, and control of the presentation based on the monitoring and based on metadata associated with the media content.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

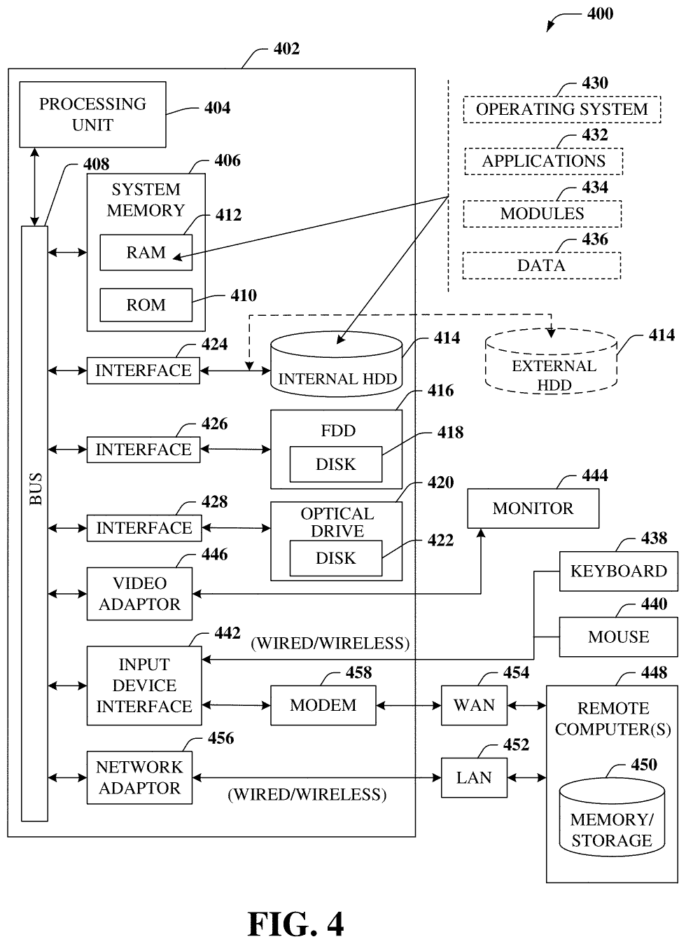

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, monitoring of a user during presentation of media content, and control of the presentation based on the monitoring and based on metadata associated with the media content.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

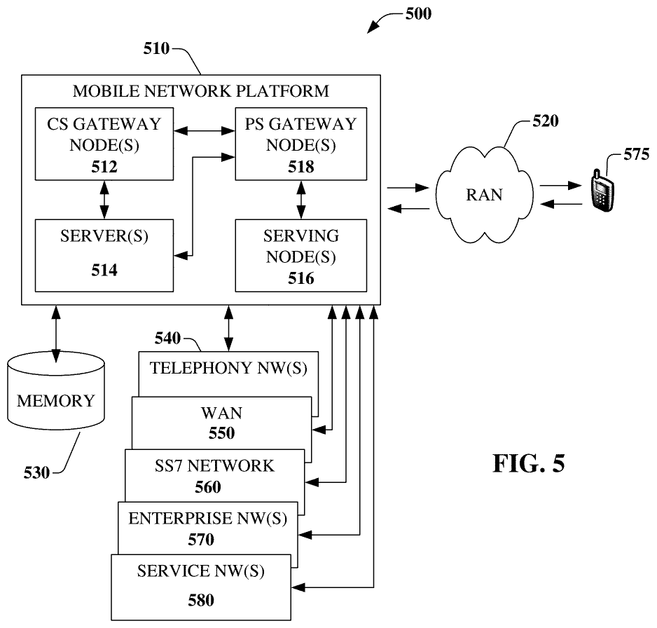

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, monitoring of a user during presentation of media content, and control of the presentation based on the monitoring and based on metadata associated with the media content. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

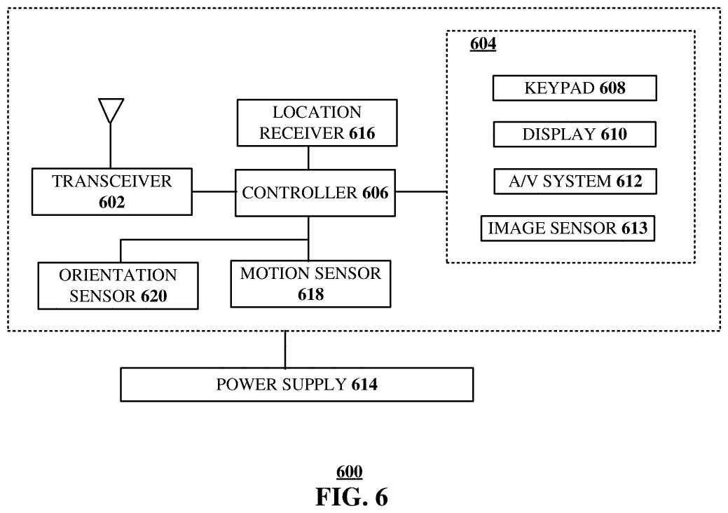

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, monitoring of a user during presentation of media content, and control of the presentation based on the monitoring and based on metadata associated with the media content.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining metadata associated with media content to be presented, wherein the metadata identifies different portions of the media content demarcated by timestamps;
during presenting of a first portion of the media content on a display device, monitoring a consumption of the media content by a user;
detecting, from the monitoring, a command provided by the user;
analyzing the command responsive to the detecting the command;
determining, based on the analyzing the command and based on the metadata, that the user desires that a second portion of the media content be played back by the display device; and
responsive to the determining that the user desires that a second portion of the media content be played back by the display device, causing the display device to switch from presenting the first portion of the media content to presenting the second portion of the media content, wherein switching to presenting the second portion of the media content is based on a particular timestamp of the timestamps that corresponds to the second portion of the media content.

2. The device of claim 1, wherein the operations further comprise:
detecting a second command provided by the user;
analyzing the second command responsive to the detecting the second command;
determining, based on the analyzing the second command, that the user desires that certain portions of the media content associated with a particular nature be played back on the display device;
identifying, based on the metadata, a plurality of portions of the media content that is associated with the particular nature; and
causing the display device to present the plurality of portions of the media content responsive to the identifying.

3. The device of claim 2, wherein the media content comprises video content, wherein the different portions of the media content comprise different scenes of the video content, wherein the metadata identifies a respective nature associated with each scene of the different scenes, and wherein the identifying the plurality of portions of the media content comprises identifying a plurality of scenes of the video content associated with the particular nature.

4. The device of claim 1, wherein each portion of the different portions of the media content is defined by a respective beginning timestamp and a respective ending timestamp, and wherein the particular timestamp is the respective beginning timestamp of the second portion of the media content.

5. The device of claim 1, wherein a presentation of the second portion of the media content occurs prior to a presentation of the first portion of the media content when the media content is played back.

6. The device of claim 1, wherein the analyzing the command involves speech-to-text conversion processing, facial recognition processing, gesture recognition processing, or a combination thereof.

7. The device of claim 1, wherein the media content comprises video content, audio content, Internet-related content, gaming content, extended reality (XR) content, or a combination thereof.

8. The device of claim 1, wherein the monitoring the consumption of the media content by the user comprises obtaining data provided by one or more sensors of the device, the display device, a monitoring device associated with the user, or a combination thereof.

9. The device of claim 1, wherein the metadata comprises, for each portion of the different portions of the media content, a description of that portion of the media content, information regarding a setting associated with that portion of the media content, information regarding one or more dialogues associated with that portion of the media content, information regarding one or more characters associated with that portion of the media content, a synopsis of that portion of the media content, or a combination thereof.

10. The device of claim 1, wherein the command comprises a voice-based command, a gesture-based command, or a combination thereof.

11. A non-transitory machine-readable medium, comprising executable instructions that, when executed by a processing system including a processor, facilitate performance of operations, the operations comprising:
receiving metadata associated with media content, wherein the metadata identifies demarcated portions of the media content;
during presenting of the media content on a media display device, monitoring a consumption of the media content by a user;
detecting, from the monitoring, that the user has likely become inattentive to the presenting of the media content;
responsive to the detecting that the user has likely become inattentive to the presenting of the media content, identifying, based on the metadata, a portion of the media content that is currently being presented, resulting in an identified portion of the media content;
identifying that the user is likely no longer inattentive to the presenting of the media content;
determining that the identified portion of the media content is to be played back responsive to the identifying that the user is likely no longer inattentive to the presenting of the media content; and
based on the determining that the identified portion of the media content is to be played back, causing the media display device to present the identified portion of the media content.

12. The non-transitory machine-readable medium of claim 11, wherein the operations further comprise receiving data regarding the user from a monitoring device, and wherein the detecting that the user has likely become inattentive to the presenting of the media content is based on the receiving the data regarding the user.

13. The non-transitory machine-readable medium of claim 11, wherein the operations further comprise detecting a command provided by the user, and wherein the identifying that the user is likely no longer inattentive to the presenting of the media content is based on the detecting the command provided by the user.

14. The non-transitory machine-readable medium of claim 11, wherein the identifying the portion of the media content that is currently being presented further comprises identifying, based on the metadata, that the portion of the media content has a particular level of significance, wherein the operations further comprise causing a prompt regarding the identified portion of the media content to be provided to the user, and wherein the identifying that the user is likely no longer inattentive to the presenting of the media content comprises detecting a user response to the prompt.

15. The non-transitory machine-readable medium of claim 11, wherein the metadata identifies timestamps that define the demarcated portions of the media content, and wherein the identifying the portion of the media content that is currently being presented is based on a beginning timestamp associated with the portion of the media content, an ending timestamp associated with the portion of the media content, and a current playback position of the media content.

16. A method, comprising:
obtaining, by a processing system of a user device including a processor, metadata associated with media content, wherein the metadata identifies different portions of the media content demarcated by timestamps;
during presenting of the media content on a media display device, monitoring, by the processing system, for reactions of a user to the presenting of the media content;
detecting, by the processing system, a particular reaction of the user based on the monitoring;
identifying, by the processing system, based on the detecting the particular reaction and based on the timestamps and a current playback position of the media content, that a first portion of the media content is currently being presented on the media display device;
responsive to the identifying, deriving, by the processing system, a message that includes information regarding the particular reaction and the first portion of the media content; and
responsive to the deriving the message, causing, by the processing system, the message to be transmitted to an external system.

17. The method of claim 16, wherein the particular reaction comprises an emotional expression, a facial expression, a verbal remark, or a combination thereof.

18. The method of claim 16, wherein the identifying that the first portion of the media content is currently being presented on the media display device is based on a beginning timestamp associated with the first portion of the media content and an ending timestamp associated with the first portion of the media content.

19. The method of claim 16, wherein the external system comprises a social media system, and wherein the causing the message to be transmitted to the external system comprises causing a social media post, that includes the information regarding the particular reaction and the first portion of the media content, to be generated on the social media system.

20. The method of claim 16, wherein the external system comprises a feedback system associated with a provider of the media content, a creator of the media content, or a combination thereof.
